(19) United States
(12) Patent Application Publication
(10) Pub. No.: US 2025/0110223 A1
(43) Pub. Date: Apr. 3, 2025

(54) Method for Controlling a Laser Rangefinder

(71) Applicant: Robert Bosch GmbH, Stuttgart (DE)

(72) Inventors: Kevin Bergmann, Uhingen (DE); Gaetan Moren, Stuttgart (DE); Joerg Stierle, Waldenbuch (DE); Michael Holzaepfel, Essingen (DE); Pia Rank, Schorndorf-Weiler (DE); Sandra Hagmayer, Ebersbach (DE)

(21) Appl. No.: 18/888,926

(22) Filed: Sep. 18, 2024

(30) Foreign Application Priority Data
Sep. 29, 2023 (DE) 10 2023 209 596.3
Oct. 6, 2023 (DE) 10 2023 209 769.9

(51) Int. Cl. G01S 7/4911; G01S 7/481; G01S 7/51

(52) U.S. Cl. CPC G01S 7/4911; G01S 7/4814; G01S 7/51

(57) ABSTRACT

A method for controlling a laser rangefinder having a control unit for carrying out the method is disclosed. The method includes (i) acquiring an actuation of a setting element of the laser rangefinder, (ii) providing an animated measurement mode visualization, and (iii) displaying the animated measurement mode visualization on a display unit of the laser rangefinder.

This application claims priority under 35 U.S.C. § 119 to (i) patent application no. DE 10 2023 209 596.3, filed on Sep. 29, 2023 in Germany, and (ii) patent application no. DE 10 2023 209 769.9, filed on Oct. 6, 2023 in Germany, the disclosures of which are incorporated herein by reference in their entirety.

The present disclosure relates to a method for controlling a laser rangefinder.

### BACKGROUND

A method for controlling a laser rangefinder, such as EP 3 602 120 B1, is already known from the prior art.

### SUMMARY

The present disclosure relates to a method for controlling a laser rangefinder comprising a control unit for carrying out the method, comprising the steps:
acquiring an actuation of a setting element of the laser rangefinder;
providing an animated measurement mode visualization;
displaying the animated measurement mode visualization on a display unit of the laser rangefinder.

The disclosure provides a method which enables a language-independent and intuitive use of measurement modes by visualizing a respective measurement mode in an animated manner. The use of the animated measurement mode visualization makes it possible to show a user which function and which measurement is hidden behind the respective measurement mode, regardless of language.

The laser rangefinder can be a handheld laser rangefinder for non-contact range measurement between the laser rangefinder and a distant object using a laser beam that can be emitted by the laser rangefinder, with a device housing and a power supply device. The control unit can be disposed in the device housing. The control unit is configured to control the laser rangefinder. The control unit comprises an information input, an information processing unit and an information output. In one embodiment, the control unit can comprise a processor as well as measurement modes and/or measurement mode visualizations and/or control routines and/or evaluation routines and/or calculation routines stored in a memory unit of the control unit. It is conceivable that a respective measurement mode, measurement mode visualization and calculation routine are stored in the memory unit. The device housing can at least partially enclose the display unit. The display unit can be configured as a display, for instance.

Acquiring an actuation of the setting element involves detecting when the user actuates the setting element. The setting element can be disposed on the device housing and configured as an actuatable setting element. The setting element can be configured as a pressing element, rotating element or sliding element, for example. The setting element is connected for signal exchange at least to the control unit, so that actuation of the actuating element is forwarded to the control unit. The device housing can at least partially enclose the setting element. It is also conceivable that the device housing encloses the setting element at least in peripheral direction. When the setting element is actuated, the user can, for instance, make a selection or switch the laser rangefinder on and/or off.

In one step of the method, a measurement mode overview is provided, in particular from the memory unit of the laser rangefinder. The measurement mode overview can display the available measurement modes on the laser rangefinder. The measurement mode overview can be retrieved from the memory unit. The control unit can provide the measurement mode overview.

In one step of the method, the measurement mode overview is visualized on the display unit. The visualization on the display unit helps the user understand the possible measurement modes. The control unit controls the display unit such that the measurement mode overview is retrieved from the memory unit and forwarded to the display unit by way of signals. The display unit then visualizes the measurement mode overview on the display unit.

In one step of the method, an actuation of a selection element for selecting the measurement mode is acquired. The selection element can be disposed on the device housing. The selection element can moreover be configured as an actuatable selection element. The selection element can be configured as a pressing element, rotating element or sliding element, for example. The selection element is connected for signal exchange at least to the control unit, so that actuation of the selection element is forwarded to the control unit. The device housing can at least partially enclose the selection element. It is also possible that the device housing encloses the selection element at least in peripheral direction. It is possible for the setting element and the selection element to be one piece. When the measurement mode overview is open and the selection element is actuated, the desired measurement mode is selected on the display unit first. The animated measurement mode visualization is then provided, which uses an animation to explain to the user which measurement mode is selected.

When the animated measurement mode visualization is provided, the animated measurement mode visualization is retrieved from the memory unit via the control unit and forwarded to the display unit. The animated measurement mode visualization uses an animation to graphically show the user which function enables a desired measurement mode. This enables an intuitive visualization of a measurement mode for the user that is language-independent. The animated measurement mode visualization can be a series and/or a sequence of images, for example, that are played in such a way that they create a kind of video. The series and/or sequence of images can be provided in a bitmap, png, jpg format or the like, for example.

When the animated measurement mode visualization is displayed on the display unit, the animated measurement mode visualization is then played as the animation. The display unit is connected for signal exchange at least to the control unit.

In one step of the method, the measurement mode is implemented by way of a ranging unit. The ranging unit can be disposed at least partially inside the device housing. The control unit is used to control the laser rangefinder. The control unit is provided to ascertain a distance from a range measurement by way of the ranging unit. The control unit can in particular be provided to ascertain a light propagation time from a phase comparison carried out between an emitted laser radiation and a laser radiation returning from a surface of a target object and to calculate or ascertain a sought distance between the laser rangefinder and the target object using the speed of light. The control unit is connected for signal exchange to the other components of the laser rangefinder, in particular a transmitting device, a detector device, an output device, such as the display unit, and also, for example, an input device, such as the setting element or the selection element, the power supply device and a data communication interface. The control unit is provided to communicate with these components during operation of the laser rangefinder and thus enable operation of the laser rangefinder.

In one step of the method, a further actuation of the selection element is checked. When the animation of the animated measurement mode visualization has ended, there is a check to see whether the user has actuated the selection element again. If the user has not actuated the selection again, essentially the same measurement mode is displayed by way of the animated measurement mode visualization. It is also possible that the display of the animated measurement mode visualization is stopped if the selection element is not actuated again. The check is carried out by way of the control unit.

In one step of the method, a further animated measurement mode visualization is provided, in particular by way of the control unit, if the selection element is actuated again. The further measurement mode visualization is retrieved in the memory unit and made available for activation. Therefore, if the user has actuated the selection element again, a further measurement mode is shown on the display unit by way of the further animated measurement mode visualization.

In one step of the method, an actuation of an activation element for activating a measurement mode displayed by way of the animated measurement mode visualization is acquired. The user can use the activation element to activate the desired measurement mode that was visualized on the display unit by way of the animated measurement mode visualization. The activation element can be disposed on the device housing and can be configured as an actuatable activation element. The activation element can be configured as a pressing element, rotating element or sliding element, for example. The activation element is connected for signal exchange at least to the control unit, so that actuation of the activation element is forwarded to the control unit. The device housing can at least partially enclose the activation element. It is also possible that the device housing encloses the activation element at least in peripheral direction. It is possible for the setting element, the selection element and the activation element to be one piece. The control unit can be configured such that it checks whether the activation element has been actuated and implements the desired measurement mode using the components. If the activation element is not actuated, the animated measurement mode visualization is repeated. If the activation element is actuated, the animated visualized measurement mode is implemented.

In one step of the method, a connection to an external adapter is ascertained. External adapters that can be connected to the laser rangefinder are known from EP 3 602 120 B1. The external adapter can be configured as an attachment adapter for the laser rangefinder. The external adapter can be connectable to an interface of the laser rangefinder. The control unit ascertains whether the external adapter is connected to an interface of the laser rangefinder. If the control unit ascertains that the external adapter is being connected, a measurement mode visualization for the external adapter is provided. A measurement mode for the external adapter can then be activated by way of the activation element and the measurement mode for the external adapter is implemented. If the control unit ascertains that no external adapter is connected, one of the above measurement mode visualizations is implemented. The control unit can check in control loops whether the external adapter is still connected to the laser rangefinder. This can be carried out as long as the external adapter is connected. As soon as the external adapter is connected to the interface of the laser rangefinder, the animated measurement mode visualization for the external adapter is provided and displayed.

The measurement mode visualization can, for instance, be a visualization for a single range measurement, a visualization for a continuous range measurement, a visualization for an area measurement, a visualization for a rounding function, a visualization of a distance measurement using a roller adapter, a visualization for an area measurement using a roller adapter, a visualization for a distance measurement using a tape adapter, a visualization for an area measurement using a tape adapter, a visualization for a horizontal alignment using a line adapter, a visualization for a vertical alignment using a line adapter or the like.

The measurement mode can, for instance, be a single range measurement, a continuous range measurement, an area measurement, a rounding function, a distance measurement using a roller adapter, an area measurement using a roller adapter, a distance measurement using a tape adapter, an area measurement using a tape adapter, a horizontal alignment using a line adapter, a vertical alignment using a line adapter or the like.

The disclosure also relates to the control unit for controlling the laser rangefinder, comprising a processor which is configured such that it can carry out the above-described method.

The disclosure also describes a laser rangefinder comprising the above-described control unit.

### BRIEF DESCRIPTION OF THE DRAWINGS

The disclosure is explained in the following with reference to a preferred embodiment. In the following, the drawings show:

FIG. 1 a schematic view of a system comprising a plurality of external adapters and a handheld laser rangefinder;

FIG. 2a method according to the disclosure for controlling the laser rangefinder;

FIG. 3 a method according to the disclosure for controlling the laser rangefinder with a connected external adapter.

### DETAILED DESCRIPTION

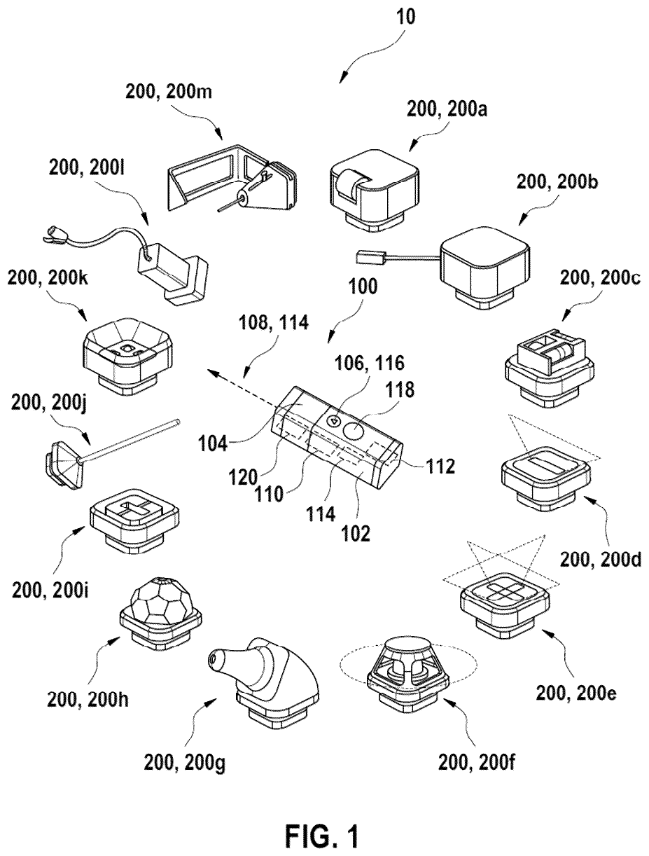

FIG. 1 shows a schematic perspective view of an example of a system 10 comprising a handheld laser rangefinder 100 for non-contact range measurement between the laser rangefinder 100 and a distant object (not shown in detail) and a plurality of external adapters 200. The handheld laser rangefinder 100 comprises a device housing 102, a display unit 104, which is configured as a display, for example, and a setting element 106.

To measure the distance of the laser rangefinder 100 to a target object (not shown in more detail here), parallel laser radiation 108 is transmitted in the direction of the target object during operation of the laser rangefinder 100 via a not further depicted transmitting optics, which consists of a not further depicted lens system, for example. The laser radiation reflected by a surface of the target object (not shown in more detail here) is directed via a not further depicted receiving optics to a not further depicted detector device and detected there. A phase comparison carried out between the emitted laser radiation 108 and the laser radiation reflected by the surface of the distant object can be used to ascertain a light propagation time, and the sought distance between the laser rangefinder 100 and the target object in the respective range measurement direction 114 (direction of the emission of the laser radiation 108) can be determined via the speed of light.

Inside the device housing 102, the laser rangefinder 100 comprises a ranging unit 120, a control unit 110, a memory unit 114 and a power supply device 112. The ranging unit 120 comprises a laser diode for generating the laser radiation 108 and a detector device that are not shown in detail. The power supply device serves to supply power to the laser rangefinder 100—as well as to an external adapter 200 possibly disposed on the laser rangefinder 100—wherein the power supply device in one embodiment example comprises a battery or a rechargeable battery, preferably a lithium ion rechargeable battery. In this embodiment example, the detector device comprises at least one single-photon avalanche diode (SPAD), preferably a SPAD array. The control unit 110 is at least provided to ascertain a light propagation time from a phase comparison carried out between the emitted laser radiation 108 and the laser radiation returning from a surface of a target object and to ascertain the sought distance between the laser rangefinder 100 and the target object using the speed of light. The control unit 110 is further provided to enable operation of the laser rangefinder 100, in particular to control and/or regulate the used components of the laser rangefinder 100. An ascertained range measurement value (and/or data information provided by a disposed external adapter 200, for example a measured value) can be further processed by the control unit 110 of the laser rangefinder 100 and/or output to a user of the laser rangefinder 100 by way of the display unit 104. The control unit 110 comprises a not further depicted processor. Stored measurement modes and/or measurement mode visualizations and/or control routines and/or evaluation routines and/or calculation routines are stored in the memory unit 114. The device housing 102 at least partially encloses the display unit 104.

The setting element 106 is disposed on the device housing 102 and is configured such that it can be actuated by the user. The device housing 102 also at least partially encloses the setting element 106. The setting element 106 here is configured as a pressing element. The setting element 106 is connected to the control unit 110 in such a way that signals can be transmitted. Using the setting element 106, the user can at least switch the laser rangefinder 100 on and/or off. By actuating the setting element 106, the user can switch the laser rangefinder 100 on and/or off, for example, and also call up a measurement mode overview.

The laser rangefinder 100 comprises a selection element 116, which is disposed on the device housing 102. In this embodiment, the setting element 106 and the selection element 116 are configured in one piece. The selection element 116 is configured such that it selects a desired measurement mode when the measurement mode overview is open. The selected measurement mode is then displayed on the display unit.

The laser rangefinder 100 comprises an activation element 118, which is disposed on the device housing 102 and can be actuated by the user. As an example, the activation element 118 is configured as a pressing element. The activation element 118 is connected at least to the control unit 110 in such a way that signals can be transmitted. The actuation of the activation element 118 is forwarded to the control unit 110. The device housing 102 at least partially encloses the activation element 118.

FIG. 1 also shows a variety of different external adapters 200 that can be disposed on a handheld laser rangefinder 100. The external adapters 200 are configured here as attachment adapters 200, for example. If necessary for differentiation, the different embodiments of the external adapters 200 are identified in the following with the reference sign indices “a” to “m”. Each of the external adapters 200 (correspondingly therefore 200a-200m) comprises an attachment housing that at least substantially surrounds, encloses and/or holds the essential functional components of the respective external adapters 200, for example electronic and/or optical components. Each of the external adapters 200 is configured such that it can be disposed reversibly at least on the laser rangefinder 100, wherein at least one additional functionality can be provided by placing the respective external adapter 200 on the laser rangefinder 100. The additional functionality can in particular provide an alternative or additional functionality of the laser rangefinder 100 that is not available without the external adapter 200.

The external adapters 200 shown in FIG. 1, which can be used with the laser rangefinder 100, include the following additional functionality in this embodiment example: The external adapter 200a is configured to provide a distance measurement functionality when it is disposed on the laser rangefinder 100. The external adapter 200b is configured to provide a tape measure functionality when it is disposed on the laser rangefinder 100. The external adapter 200c is configured to provide a leveling functionality when it is disposed on the laser rangefinder 100. The external adapter 200d is configured to redirect the emitted laser beam 108 of the laser rangefinder 100 when it is disposed on the laser rangefinder 100 using at least one optical element, in particular using a cylinder lens, in such a way that a laser line that can be projected onto a distant object is created (an emitted fan is indicated with a dashed line). The external adapter 200e is configured to redirect the emitted laser beam 108 of the laser rangefinder 100 when it is disposed on the laser rangefinder 100 using at least two cylinder lenses in such a way that two laser lines that can be projected on a distant object and intersect one another at a 90° angle are created (two emitted fans are indicated with dashed lines). The external adapter 200f is configured to redirect the emitted laser beam 108 when it is disposed on the laser rangefinder 100 using a not further depicted mirror. The external adapter 200f is provided to redirect the laser beam 108 using a reflective conical mirror in such a way that a laser line that can be projected onto a distant object is created, in particular a laser line that can be projected onto a distant object over an angular range of 360° (a fan emitted over the angular range of 360° is indicated with a dashed line). The external adapter 200g is configured to provide a temperature measurement functionality when it is disposed on the laser rangefinder 100. The external adapter 200h is configured to provide an air pressure measurement functionality and a humidity measurement functionality an an air temperature measurement functionality and a carbon dioxide measurement functionality when it is disposed on the laser rangefinder 100. The external adapter 200i comprises a communication interface for wireless communication with an external data device, wherein the communication interface is configured to transmit information to an external data device or from an external data device. The external adapter 200j is configured to provide a moisture measurement functionality when it is disposed on the laser rangefinder 100. The external adapter 200k comprises a light source in the form of multiple LEDs, so that laser rangefinder 100 can then be used as a flashlight. The external adapter 2001 is configured to provide an air pressure measurement functionality, in particular for measuring a tire air pressure, when it is disposed on the laser rangefinder 100. The external adapter 200m is configured to provide a profile depth measurement functionality when it is disposed on the laser rangefinder 100.

Using the various external adapters 200 (here in particular 200a-200m) makes it possible to provide a wide range of additional functionality for the laser rangefinder 100 that would not be available without the respective external adapters 200. In particular external adapters 200 with electrical additional functions, for example with sensors, motors, diodes or the like (not shown in more detail here) can be used, in which case the power supply of the respective external adapter 200 is advantageously provided using the power supply device 112 of the laser rangefinder 100.

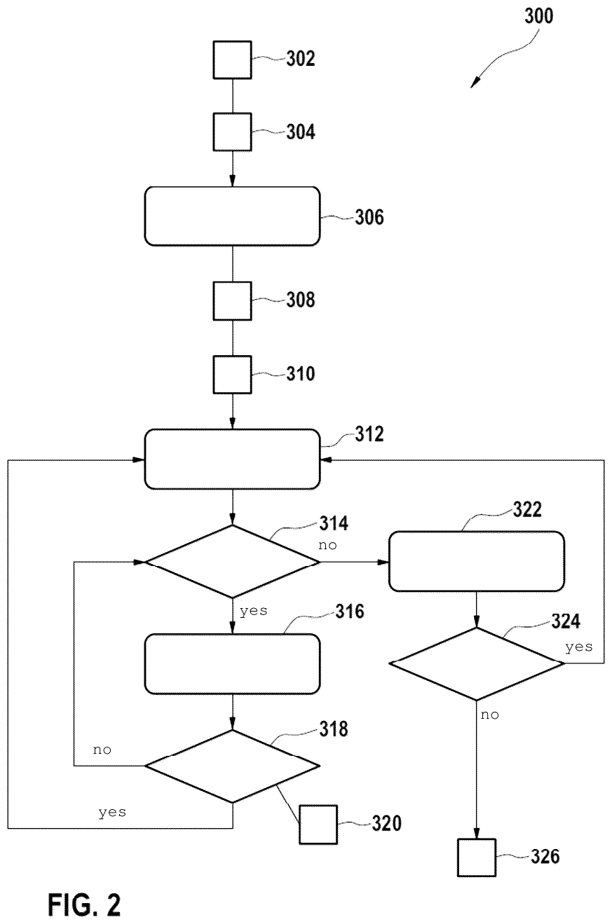

FIG. 2 shows a method 300 according to the disclosure for controlling the laser rangefinder 100. The control unit 110 is configured to carry out the method 300. In a method step 302, the actuation of the setting element 106 is acquired. The control unit 110 thus recognizes that the user wants to use the laser rangefinder 100.

In a method step 304, the measurement mode overview is provided. The control unit 110 retrieves the measurement mode overview from the memory unit 114. The measurement mode overview enables a display of available measurement modes for the laser rangefinder 100.

In a method step 306, the measurement mode overview is visualized on the display unit 104. The available measurement modes are displayed to the user. The control unit 110 controls the display unit 104 such that the measurement mode overview is retrieved from the memory unit 114 and forwarded to the display unit 104 by way of signals.

In a method step 308, an actuation of the selection element 116 for selecting the measurement mode is acquired. The user selects the desired measurement mode from the measurement mode overview by switching between the different measurement modes using the selection element 116. The switching here is accomplished by repeatedly actuating the selection element 116.

In a method step 310, an animated measurement mode visualization of the desired measurement mode is provided. The control unit 110 retrieves the animated measurement mode visualization from the memory unit 114 after the selection element 116 has been actuated and makes it available to the display unit 104 by way of signals.

In a method step 312, the animated measurement mode visualization is displayed on the display unit 104. The animated measurement mode visualization is played as an animation. In a method step 314, a further actuation of the selection element 116 is checked. If the user has actuated the selection element 116 again, the same or another animated measurement mode visualization is displayed on the display unit 104 in a method step 316. In a method step 318, there is a check to see whether the display of the animated measurement mode visualization has been ended. In a method step 320, an actuation of the activation element 118 for activating the measurement mode displayed by way of the animated measurement mode visualization is acquired. The desired measurement mode is then implemented using the ranging unit 120.

If the selection element 116 has not been actuated again, the display of the animated measurement mode visualization is stopped in a method step 322. In a method step 324, there is a check to see whether another measurement mode has been selected. If another measurement mode has been selected, an associated measurement mode visualization is displayed, which is carried out in method step 312.

If no other measurement mode has been selected, the laser rangefinder 100 is switched off in a method step 326.

In a method step 320 of the method, an actuation of an activation element for activating a measurement mode displayed by way of the animated measurement mode visualization is acquired. The user can use the activation element to activate the desired measurement mode that was visualized on the display unit by way of the animated measurement mode visualization. The desired measurement mode is then implemented using the ranging unit 120.

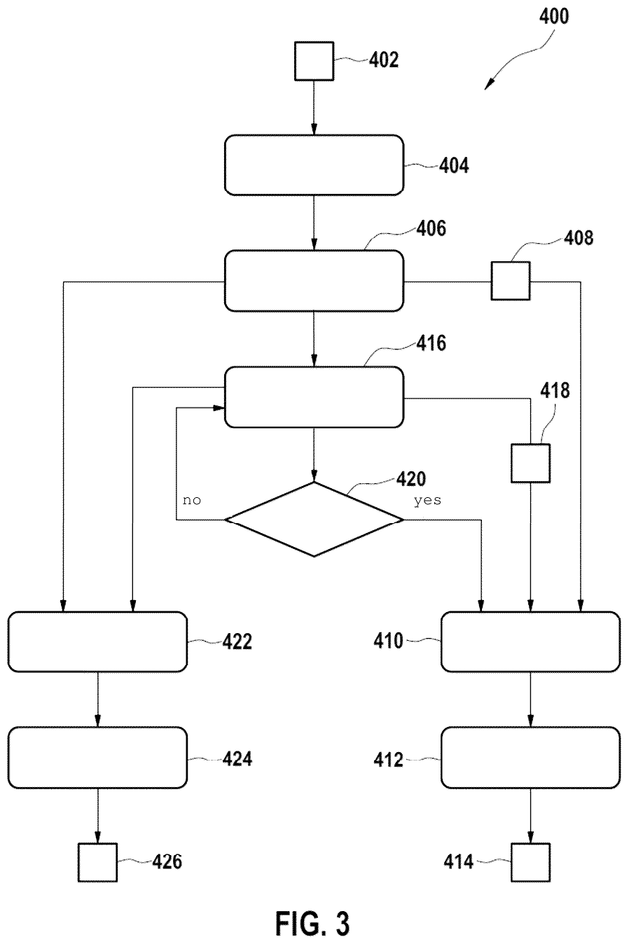

FIG. 3 shows a method 400 according to the disclosure for controlling the laser rangefinder 100 with a connected external adapter 200. In a method step 402, a connection to the external adapter 200 is ascertained. If the control unit 110 ascertains that the external adapter 200 is being connected, a measurement mode visualization for the external adapter 200 is provided.

In a method step 404, the connection to the external adapter 200 is detected. An animated measurement mode visualization for the connected external adapter 200 is provided from the memory unit 114 by the control unit 110. In a method step 406, the animated measurement mode visualization is displayed on the display unit 104. In a method step 408, it is ascertained whether the activation element 118 is being actuated. In a method step 410, the display of the animated measurement mode visualization is stopped. Subsequently, the selected measurement mode is activated in a method step 412 if the activation element 118 has been actuated. The control unit 110 then controls the ranging unit 120 such that the ranging unit 120 implements the selected measurement mode. In a method step 414, the laser rangefinder 100 is then switched off.

If there is no action by the user in method step 406, the animated measurement mode visualization is processed in a method step 416 and it cycles through a sequence of different series of images. In a method step 418, it is ascertained whether the activation element 118 has been actuated. If this is the case, the animated measurement mode visualization is stopped in the method step 410 and the measurement mode is implemented in the method step 412.

If there is no action in method step 416, there is a check in a method step 420 to see whether the sequence of the different series of images has been completed. If this is the case, the animated measurement mode visualization is stopped in the method step 410 and the measurement mode is implemented in the method step 412.

If the control unit 110 detects in the method step 406 that the connection between the external adapter 200 and the laser rangefinder 100 has been disconnected, the animated measurement mode visualization is stopped in a method step 422. The measurement mode visualization for the external adapter 200 is then ended in a method step 424. In a method step 426, the laser rangefinder 100 can be switched off or the laser rangefinder can carry out the method 300.

If it is detected in the method step 416 that the connection between the external adapter 200 and the laser rangefinder 100 has been disconnected, the animated measurement mode visualization is stopped in the method step 422. The method steps 424 and 426 are then carried out.

What is claimed is:

1. A method for controlling a laser rangefinder, comprising:
acquiring an actuation of a setting element of the laser rangefinder;
providing an animated measurement mode visualization; and
displaying the animated measurement mode visualization on a display unit of the laser rangefinder.

2. The method according to claim 1, further comprising providing a measurement mode overview from a memory unit of the laser rangefinder.

3. The method according to claim 2, further comprising visualizing the measurement mode overview on the display unit.

4. The method according to claim 1, further comprising acquiring an actuation of a selection element for selecting a measurement mode.

5. The method according to claim 4, further comprising implementing the measurement mode by way of a ranging unit.

6. The method according to claim 4, further comprising checking a further actuation of the selection element.

7. The method according to claim 6, further comprising providing a further animated measurement mode visualization for the further actuation of the selection element.

8. The method according to claim 1, further comprising acquiring an actuation of an activation element for activating a measurement mode displayed by way of the animated measurement mode visualization.

9. The method according to claim 1, further comprising ascertaining a connection to an external adapter.

10. A control unit for controlling a laser rangefinder comprising a processor which is configured such that it carries out the method according to claim 1.

11. A laser rangefinder comprising the control unit according to claim 10.

12. The method according to claim 1, wherein the laser rangefinder includes a control unit configured to carry out the method.
